(19) United States
(12) Patent Application Publication
(10) Pub. No.: US 2016/0109603 A1
(43) Pub. Date: Apr. 21, 2016

(54) METHOD AND APPARATUS FOR CHARACTERIZING ELASTIC ANISOTROPY FOR TRANSVERSELY ISOTROPIC UNCONVENTIONAL SHALE

(71) Applicants: Guodong Jin, Katy, TX (US); Hector Jose Gonzalez Perez, Al Khobar (SA); Gaurav Agrawal, Aurora, CO (US)

(72) Inventors: Guodong Jin, Katy, TX (US); Hector Jose Gonzalez Perez, Al Khobar (SA); Gaurav Agrawal, Aurora, CO (US)

(73) Assignee: BAKER HUGHES INCORPORATED, Houston, TX (US)

(21) Appl. No.: 14/516,176

(22) Filed: Oct. 16, 2014

(51) Int. Cl. G01V 1/46; E21B 49/00

(52) U.S. Cl. CPC G01V 1/46; E21B 49/00

(57) ABSTRACT

A method for estimating elastic properties of a subsurface material having a bedding plane includes disposing a single sample of the subsurface material in a core holder, the core holder having (i) a first acoustic transducer set having a first acoustic source and a first acoustic receiver and (ii) a second acoustic transducer set having a second acoustic source and a second acoustic receiver. The method also includes performing at least five acoustic wave velocity measurements on the single sample that include compressional acoustic wave velocities and shear wave acoustic velocities with a certain direction of shear acoustic wave polarization using the first set of acoustic transducers and the second set of acoustic transducers, estimating, with a controller, the elastic properties using the at least five acoustic wave velocity measurements, and providing an output signal having the elastic properties to an output signal receiving device.

### BACKGROUND

Many reservoirs made up of unconventional rock such as shale source rock are being used today to produce hydrocarbons. Determination of elastic properties of shale source rock is crucial for reservoir characterization and development. Knowledge of these properties helps determine the well spacing and hydraulic fracturing design among other engineering design parameters. Hence, any improvements in methods and apparatus for characterizing shale source rock would be well received in the hydrocarbon production industry.

### BRIEF SUMMARY

Disclosed is a method for estimating elastic properties of a subsurface material having a bedding plane. The method includes: disposing a single sample of the subsurface material in a core holder, the core holder having (i) a first acoustic transducer set having a first acoustic source and a first acoustic receiver and (ii) a second acoustic transducer set having a second acoustic source and a second acoustic receiver; performing at least five acoustic wave velocity measurements on the single sample that include compressional acoustic wave velocities and shear wave acoustic velocities with a certain direction of shear acoustic wave polarization using the first set of acoustic transducers and the second set of acoustic transducers; estimating, with a controller, the elastic properties using the at least five acoustic wave velocity measurements; and providing an output signal that includes the elastic properties to an output signal receiving device.

Also disclosed is an apparatus for estimating elastic properties of a subsurface material having a bedding plane. The apparatus includes a core holder configured to hold a single sample of the subsurface material, a first acoustic transducer set coupled to the core holder and having a first acoustic source and a first acoustic receiver, and a second acoustic transducer set coupled to the core holder and having a second acoustic source and a second acoustic receiver. The apparatus further includes a controller coupled to the first acoustic transducer set and the second acoustic transducer set, the controller being configured to (i) control operation of the first acoustic transducer set and the second acoustic transducer set in order to measure at least five acoustic wave velocities that include compressional acoustic wave velocities and shear wave acoustic velocities with a certain direction of shear acoustic wave polarization and (2) estimate the elastic properties using the at least five acoustic wave velocities that include compressional acoustic wave velocities and shear wave acoustic velocities with a certain direction of shear acoustic wave polarization.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of an exemplary embodiment of a coring tool disposed in a borehole penetrating the earth;

FIG. 2 depicts aspects of a transversely isotropic medium with a vertical symmetry axis;

FIG. 3 depicts aspects of the state of stress at an arbitrary point P in the medium;

FIG. 4 depicts aspects of extracting three core plugs from a core sample for measuring the transducers isotropy;

FIGS. 5A-5C, collectively referred to as FIG. 5, depict aspects of performing velocity measurements on the three core plugs;

FIGS. 6A-6D, collectively referred to as FIG. 6, depict aspects of positions of two sets of acoustic transducers for measuring acoustic velocities in one core sample;

FIGS. 7A-7C, collectively referred to as FIG. 7, depict aspects of a core holder for holding the core sample and positioning the sets of acoustic transducers in contact with the core sample;

FIGS. 8A-8C, collectively referred to as FIG. 8, depict aspects of one embodiment for positioning three sets of acoustic transducers in contact with the single core sample;

FIGS. 9A and 9B, collectively referred to as FIG. 9, depict aspects of another embodiment for positioning three sets of acoustic transducers in contact with the single core sample;

FIG. 10 depicts aspects of a core holder for conducting acoustic wave velocity measurements on a single core sample in a cross-sectional view; and

FIG. 11 is a flow chart for a method for estimating a property of a subsurface material.

### DETAILED DESCRIPTION

A detailed description of one or more embodiments of the disclosed apparatus and method presented herein by way of exemplification and not limitation with reference to the figures.

Disclosed are method and apparatus for estimating properties of a subsurface material. In one or more embodiments, the properties are elastic anisotropy constants of transversely isotropic reservoir rocks such as unconventional shale. A core sample of the unconventional shale is extracted using a downhole tool conveyed through a borehole and brought the surface of the earth. Once the core sample is extracted from the formation, it is usually transported to laboratory or test facility at which the sample can be acoustically interrogated and the properties estimated. To fully characterize the elastic properties of the transversely isotropic reservoir rock, three Thomsen anisotropy parameters with five independent elastic constants are required. In the laboratory, this translates to measuring at least three separate adjacent core plugs with different orientations—one parallel, one perpendicular, and one at 45 degrees to the bedding planes. This can be a practical bottleneck—it is difficult to drill multiple adjacent core plugs with good quality from a whole core due to its brittleness. Consequently, rock-physics data on acoustic velocity and anisotropy in shales has remained scarce. The present method and apparatus for characterizing the elastic anisotropy of transversely isotropic reservoir rocks uses only one core plug. The core sample is placed in a core holder that applies downhole environmental conditions to the sample. Sets of acoustic transducers are positioned with respect to surfaces or planes of isotropy and held in contact with the core sample by the core holder. Acoustic velocity measurements are then performed and an elasticity value of the core sample and thus the subsurface material is determined from the measurements.

Most gas shales are considered to be intrinsically transversely isotropic, with the symmetry axis generally aligned with the vertical. In the present method and apparatus, this one plug is extracted parallel to the bedding of the whole core. In one or more embodiments, this plug is non-destructively measured in multiple configurations to yield composite information similar to what would be obtained from three plugs of different bedding angles. The sample is jacketed in a core holder, specifically designed to measure six wave velocities at each pressure/temperature step: axial compressional, two axial shear, radial compressional, and two radial shear. By adjusting the relative position of the sample bedding to the radial velocity transducers, variation of measured velocities with angles is determined, yielding the elastic constants and Thomsen parameters. In addition, the core holder enables velocity measurements under in-situ reservoir stress, pore pressure and temperature.

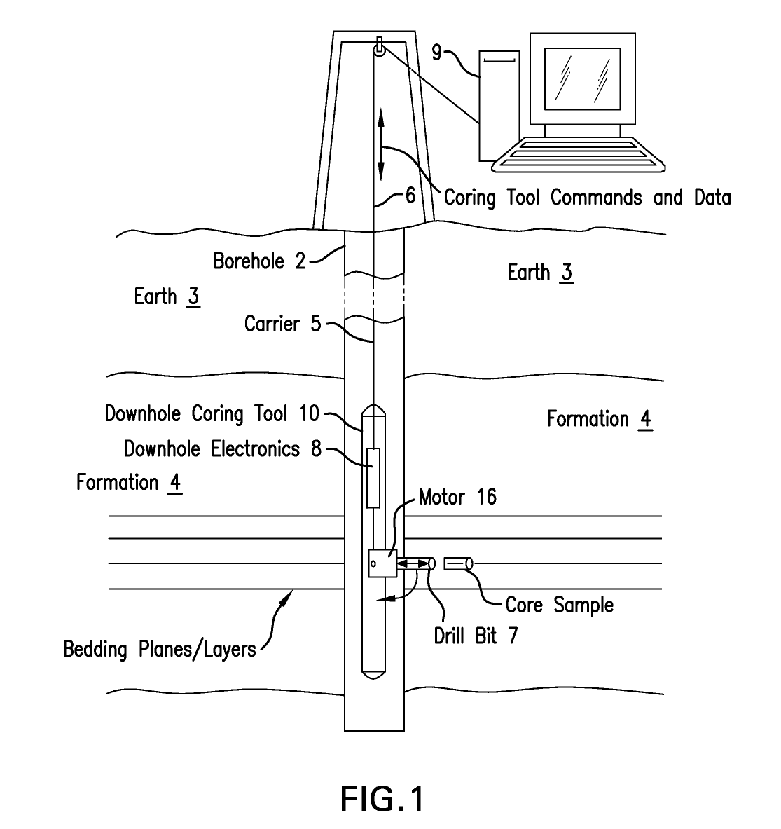

Next, apparatus for extracting a core sample from a formation is discussed. FIG. 1 illustrates a cross-sectional view of a downhole tool 10 disposed in a borehole 2 penetrating the earth 3, which includes an earth formation 4 having a bedding plane (or layer) or parallel bedding planes. The formation 4 represents any subsurface material of interest that may be characterized using the method and apparatus disclosed herein. The downhole tool 10 is configured to extract a core sample from the formation 4 through a sidewall of the borehole 2. In order to extract the core sample, the tool 10 includes a hollow drill bit 7 that is operated by a motor 16. The drill bit 7 is configured to drill through the sidewall and into the formation 4. The core sample is thus contained the hollow portion of the drill bit 7. Once the core sample is extracted it is disposed within the downhole tool 10 and retrieved when the downhole tool 10 is removed from the borehole. Other techniques for extracting the core sample and transporting it to the surface may also be employed.

The downhole tool 10 is conveyed through the borehole 2 by a carrier 5. In the embodiment of FIG. 1, the carrier 5 is an armored wireline 6. Besides supporting the downhole tool 10, the wireline 6 can provide communications (i.e., telemetry) between the downhole tool 10 and a computer processing system 9 disposed at the surface of the earth 3. Communications can include sending measurements uphole to the computer processing system 9 or commands downhole to the downhole tool 10. In order to operate the downhole tool 10 and/or provide a communications interface with the surface computer processing system 9, the downhole tool 10 includes downhole electronics 8. The operating and processing functions (i.e., control functions) of the disclosure may be performed by the downhole electronics 8, the computer processing system 9, or a combination thereof. Hence, the downhole electronics 8 and/or the computer processing system 9 may be referred to as a controller. In an alternative embodiment referred to as logging-while-drilling (LWD) or measurement-while-drilling (MWD), the carrier 5 can be a drill string or drill tubular.

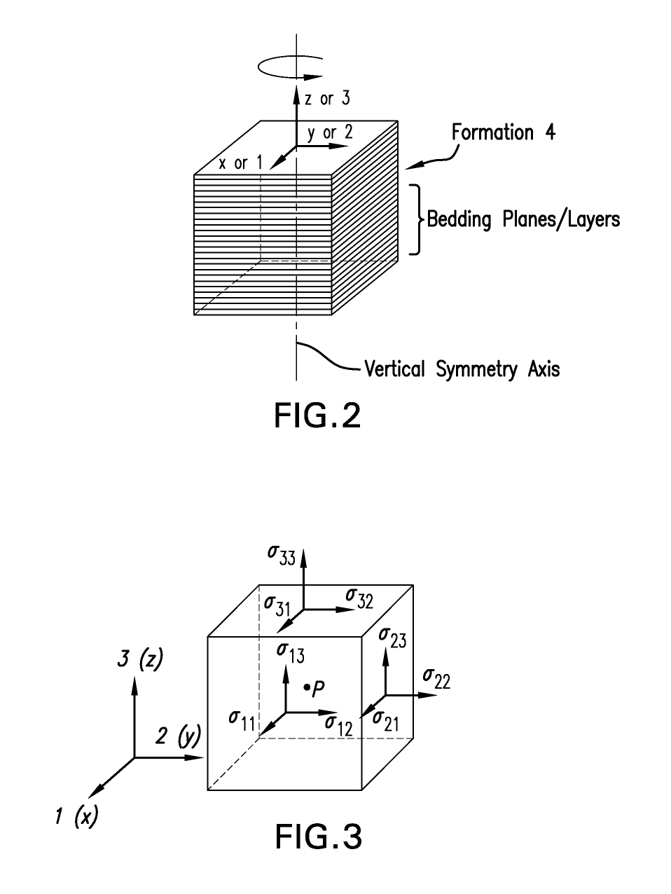

Most gas shales are considered to be intrinsically transversely isotropic (TI) medium. Such a medium is characterized by the existence of a single plane of isotropy and one single axis of rotational symmetry, the normal to the isotropy plane as illustrated in FIG. 2. The state of stress at an arbitrary point P of the medium can be defined by a stress tensor [σ]:

$$[ σ ] = {σ}_{ij} = [ \begin{matrix}{σ}_{11} & {σ}_{12} & {σ}_{13} \\ {σ}_{21} & {σ}_{22} & {σ}_{23} \\ {σ}_{31} & {σ}_{32} & {σ}_{33}\end{matrix} ] , \\ i , j = 1 , 2 , 3$$

where the stress component σᵢⱼ is defined as acting on the i-plane and being oriented in the j direction. The point P is imaged as an infinitesimal small cube as illustrated in FIG. 3. Components of the stress tensor with repeating indices, e.g., σ₁₁, are denoted as normal stress while a stress component with different indices is called a shear stress. By consideration of moment equilibrium of the medium, one can find that σᵢⱼ=σⱼᵢ.
Therefore, only six independent stress components are required to define completely the state of stress at any point P.

When an elastic body is subjected to stress, changes in size and shape occur and these deformations are called strain. Similarly, the strain at point P is determined by the strain tensor [ε]:

$$[ ɛ ] = {ɛ}_{ij} = [ \begin{matrix}{ɛ}_{11} & {ɛ}_{12} & {ɛ}_{13} \\ {ɛ}_{21} & {ɛ}_{22} & {ɛ}_{23} \\ {ɛ}_{31} & {ɛ}_{32} & {ɛ}_{33}\end{matrix} ] , \\ i , j = 1 , 2 , 3$$

The component of the strain tensor with repeating indices are denoted as normal strain, all others as shear strain. Just as the stress tensor the strain tensor has six independent components, e.g., εᵢⱼ=εⱼᵢ.

Stress and strain are related to each other by Hooke's Law where the strain is assumed to be sufficient small that stress and strain depend linearly on each other. For the transversely isotropic media, it can be written as

$$[ \begin{matrix}{σ}_{11} \\ {σ}_{22} \\ {σ}_{33} \\ {σ}_{23} \\ {σ}_{31} \\ {σ}_{12}\end{matrix} ] = [ \begin{matrix}{C}_{11} & {C}_{12} & {C}_{13} & 0 & 0 & 0 \\ {C}_{12} & {C}_{11} & {C}_{13} & 0 & 0 & 0 \\ {C}_{13} & {C}_{13} & {C}_{33} & 0 & 0 & 0 \\ 0 & 0 & 0 & {C}_{44} & 0 & 0 \\ 0 & 0 & 0 & 0 & {C}_{44} & 0 \\ 0 & 0 & 0 & 0 & 0 & {C}_{66}\end{matrix} ] [ \begin{matrix}{ɛ}_{11} \\ {ɛ}_{22} \\ {ɛ}_{33} \\ {γ}_{23} = 2 {ɛ}_{23} \\ {γ}_{31} = 2 {ɛ}_{31} \\ {γ}_{12} = 2 {ɛ}_{12}\end{matrix} ]$$

$$with$$

$${C}_{12} = {C}_{11} - 2 {C}_{66} .$$

From the above matrix equation, there are five non-zero independent elastic constants: C₁₁, C₃₃, C₁₃, C₄₄, and C₆₆. Here, C₁₁ is the in-plane (parallel to the plane of isotropy) compressional modulus, C₃₃, is the out-of-plane (perpendicular to the plane of isotropy) compressional modulus, C₄₄, is the out-of-plane shear modulus, and C₆₆ the in-plane shear modulus, C₁₃ is a constant that controls the shape of the wave surfaces.

To characterize the anisotropy degree of a medium, Thomsen (1986) introduced three anisotropy parameters ε, δ, and γ, which represent combinations of the five independent elastic constants:

$$ε = \frac{{C}_{11} - {C}_{33}}{2 {C}_{33}}$$

$$γ = \frac{{C}_{66} - {C}_{44}}{2 {C}_{44}}$$

$$δ = \frac{{( {C}_{13} + {C}_{44} )}^{2} - {( {C}_{33} - {C}_{44} )}^{2}}{2 {C}_{33} ( {C}_{33} - {C}_{44} )}$$

where ε reflects the degree of anisotropy of the compressional wave propagating in the medium; δ reflects the degree of anisotropy of the shear wave. These parameters allow for a statement like “anisotropy is x %”; If they are less than 0.1, the medium can be assumed to be “weakly anisotropic”.

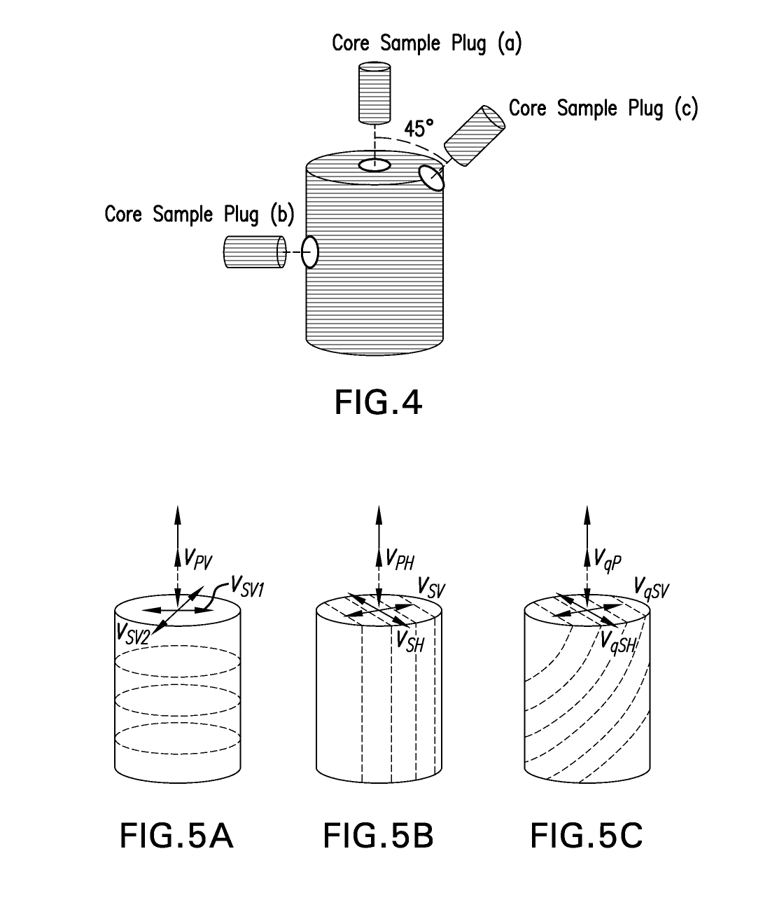

Determination of the five independent elastic constants above requires five independent wave measurements. One way is to measure the velocities on three core plugs cut from a single whole core sample in three different orientations as illustrated in FIG. 4. The three plugs are cut in three different orientations: one parallel to the bedding planes, one perpendicular to the bedding planes and one at 45 degrees to the cylindrical symmetry axis in order to derive the five independent elastic constants. FIG. 5 illustrates the three plugs individually where the dashed lines represent the bedding planes, the dashed arrows represent compression waves, and the solid arrows represent wave polarization directions. In FIG. 5A, the plug cut normal to the bedding planes. In FIG. 5B, the plug is cut parallel to the bedding planes. In FIG. 5C, the plug is cut at 45 degrees to the symmetry axis. According to the wave polarization and propagation directions with respect to the bedding-parallel lamination, nine velocities can be measured. For propagation perpendicular to the bedding, there are a vertically propagating compressional wave (V_{PV}) and two vertically propagating shear waves (V_{SV1} and V_{SV2}). For propagation parallel to the bedding, there are a horizontally propagating compressional wave (V_{PH}), a shear wave (V_{SV}) with horizontal propagation and vertical polarization, and a shear wave (V_{SV}) with horizontal propagation and polarization direction. For propagation at 45 degree relative to the axis of symmetry, there are a quasi-compressional wave (V_{qP}) with the same polarization direction as propagation direction, and two quasi-shear waves (V_{qSV} and V_{qSH}).

Only five wave velocities are required to calculate the five elastic constants: V_{PV}, V_{SV1}=V_{SV2}, V_{PH}, V_{SH}, and V_{qP}. They are related through the following equations:

$${C}_{11} = {ρ ( {V}_{PH} )}^{2}$$

$${C}_{33} = {ρ ( {V}_{PV} )}^{2}$$

$${C}_{44} = {ρ ( {V}_{SV 1} )}^{2}$$

$${C}_{66} = {ρ ( {V}_{SH} )}^{2}$$

$${C}_{13} = - {C}_{44} + \sqrt{\begin{matrix}4 {{ρ}^{2} ( {V}_{q} p )}^{4} - 2 {ρ ( {V}_{q} p )}^{2} ( {C}_{11} + {C}_{33} + 2 {C}_{44} ) + \\ ( {C}_{11} + {C}_{44} ) ( {C}_{33} + {C}_{44} )\end{matrix}}$$

Extracting three plugs at different angles from a single cylindrical core sample can be a practical bottleneck because it is difficult to drill multiple adjacent core plugs with good quality from a whole core due to its brittleness. The method and apparatus disclosed herein of characterizing the elastic anisotropy of transversely isotropic reservoir rocks uses only one horizontal core plug such as the one illustrated in FIG. 5B. This one plug is extracted parallel to the bedding of the whole core and may be extracted in a laboratory or test facility from a single whole cylindrical core sample when that sample is transported to the surface of the earth. In one or more embodiments this plug is non-destructively measured in multiple configurations to yield composite information similar to what would be obtained using three separate plugs.

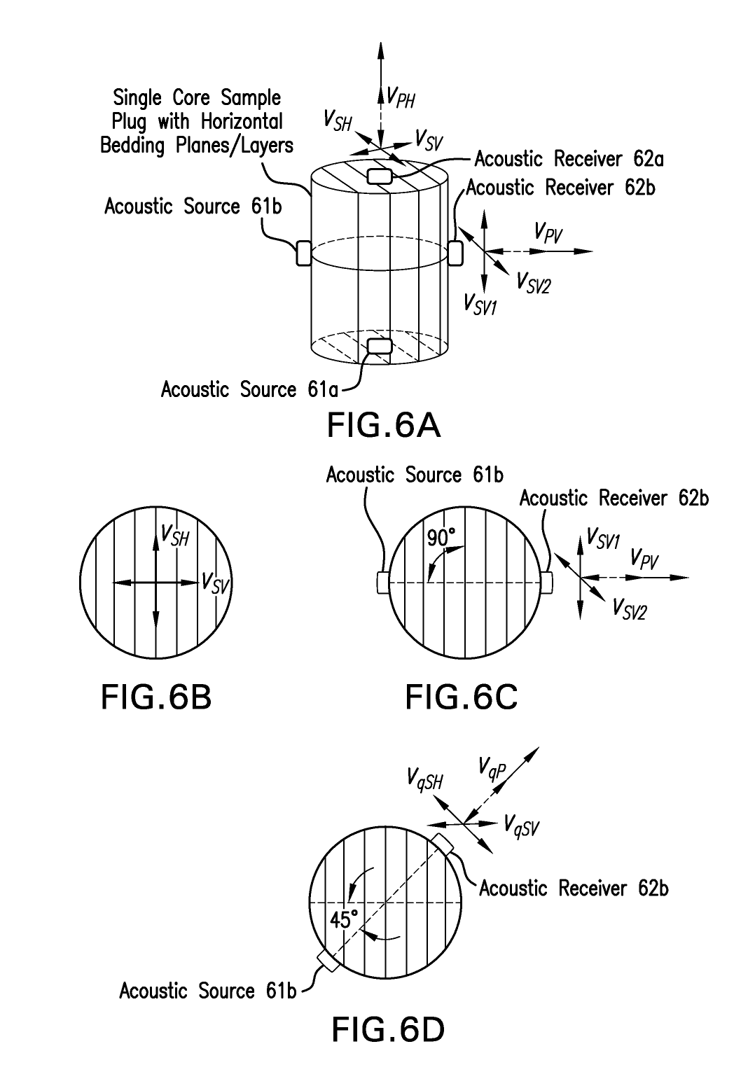

The single sample is jacketed in a core holder (discussed below), specifically designed to measure six wave velocities at one or more pressure and/or temperature steps as illustrated in FIG. 6. The core holder enables acoustic wave velocity measurements under in-situ reservoir conditions such as stress (i.e., pressure), pore pressure and temperature. In FIG. 6, apparatus for measuring axial compressional wave velocity (FIG. 6A), two axial shear wave velocities (FIGS. 6A and 6B), radial compressional wave velocity (FIG. 6C), and two radial shear wave velocities (FIG. 6C) is illustrated. These different wave velocity measurements yield the elastic constants and thus the Thomsen parameters. An axial acoustic wave source 61a and axial acoustic wave receiver 62a make up one axial acoustic transducer set and are specifically placed on the plug sample by the core holder so that two shear waves are polarized parallel and perpendicular to the bedding planes. Radial acoustic wave source 61b and radial acoustic wave receiver 62b make up a radial acoustic transducer set and are placed on the plug sample so that the set is aligned perpendicular to the bedding plane of the plug sample. In addition, either the radial transducer set or the plug sample is rotated with respect to each other 45 degrees so that the acoustic waves emitted by the radial source 61b for another velocity measurement propagate along the 45 degree angle relative to the bedding planes or layers as illustrated in FIG. 6D. In general, these acoustic wave velocity measurements are performed sequentially in order to avoid interference between the different types of wave velocity measurements. However, in some cases some of the acoustic wave velocity measurements may be performed simultaneously if interference or cross-talk does not substantially affect those measurements. In one or more embodiments, the bedding planes/layers are horizontal in the earth formation, but they are illustrated in FIG. 6 as being vertical when placed in the core holder.

Each acoustic wave source 61 is a transducer that is configured to convert an electrical signal into an emitted acoustic wave. Each acoustic wave receiver 62 is a transducer that is configured to convert a received acoustic wave into an electrical signal indicative of the received acoustic wave. Any or all of the acoustic transducers may be driven by piezoelectric operation, electromagnetic operation, or magnetostrictive operation as non-limiting embodiments. It can be appreciated that acoustic transducers for transmitting and receiving compression waves and/or shear waves having a desired direction or directions of polarization are commercially available. Each of the acoustic sources and receivers are coupled, such as electrically connected by electrical conductors, to a controller 60. The controller 60 has a structural configuration to enable the controller to control operation of the acoustic sources and receivers in order to measure the velocity of the different types of acoustic waves for interrogating the sample plug such as illustrated in FIG. 6. In one or more embodiments, the controller 60 is implemented by electronics or by a computer processing system having computer-executable instructions and hardware for implanting those instructions for measuring the various acoustic wave velocities. In one or more embodiments, the controller is configured to measure the travel time of the acoustic wave as it travels from the source transducer to the receiver transducer and to calculate the acoustic wave velocity by dividing the known distance between the source and receiver transducers by the measured travel time. The controller may also be configured to calculate the Thomsen parameters using the various measured acoustic wave velocities and to output results to a user using an output interface connected to an output device such as a display, recorder, printer or other processing system.

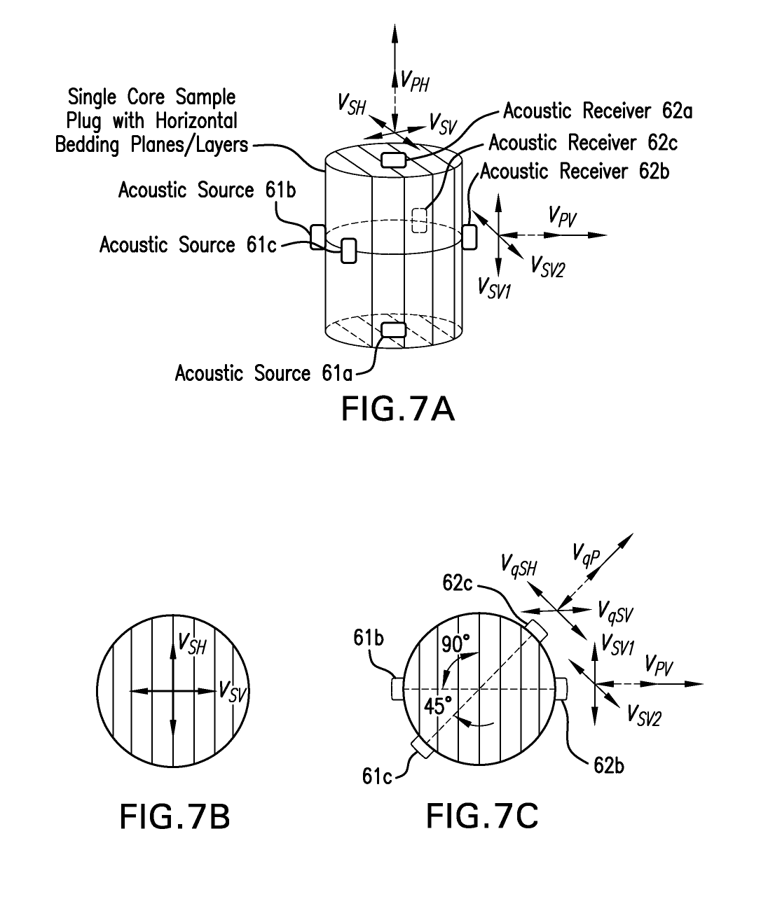

In another embodiment, the core holder includes three sets of transducers—one axial transducer set and two radial transducer sets as illustrated in FIG. 7. One set of source and receiver transducers are attached on the two ends of the plug to measure the axial compressional and shear-wave velocities. The positions of source and receiver are placed in such a way that the two shear-waves are polarized parallel and perpendicular to the bedding/layer direction as illustrated in FIGS. 7A and 7B. The other two sets of source and receiver transducers are attached on the side face (radial direction) of the plug by the core holder to measure the radial compressional and shear-wave velocities. One radial set of source and receiver transducers are placed in such a way that the waves propagate perpendicular to the bedding/layer direction as illustrated in FIGS. 7A and 7C. The other radial set (61c and 62c) is placed in a position in which waves propagates along the 45 degree direction with respect to the bedding/layer direction as illustrated in FIGS. 7A and 7C. This embodiment avoids having to rotate the radial transducer set or the sample plug 45 degrees to perform another acoustic wave velocity measurement.

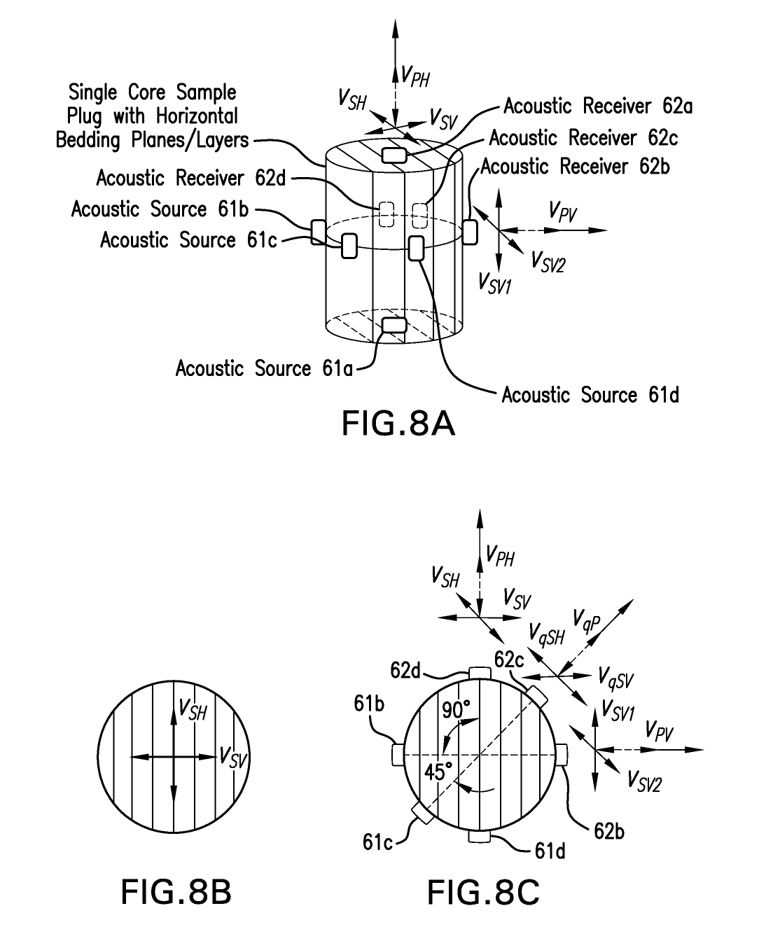

In another embodiment, the core holder includes four sets of transducers—one axial transducer set and three radial transducer sets as illustrated in FIG. 8. One axial set of source and receiver transducers are attached on the two ends of the plug to measure the axial compressional and shear-wave velocities. The positions of axial source and receiver transducers are placed in such a way that the two shear-waves are polarized parallel and perpendicular to the bedding/layer direction as illustrated in FIGS. 8A and 8B. The three radial sets of source and receiver transducers are attached on the side face (radial direction) of the sample plug to measure the radial compressional and shear-wave velocities. The first radial set of source and receiver transducers (61b and 62b) are placed in such a way that the waves propagate perpendicular to the bedding/layer direction as illustrated in FIG. 8C. The second radial set of source and receiver transducers (61c and 62c) are placed in a position in which acoustic waves propagate along the 45 degree direction relative to the bedding/layer direction as illustrated in FIG. 8C. The third radial set of source and receiver transducers (61d and 62d) is placed in such a way that the acoustic waves propagate parallel to the bedding/layer direction as illustrated in FIG. 8C.

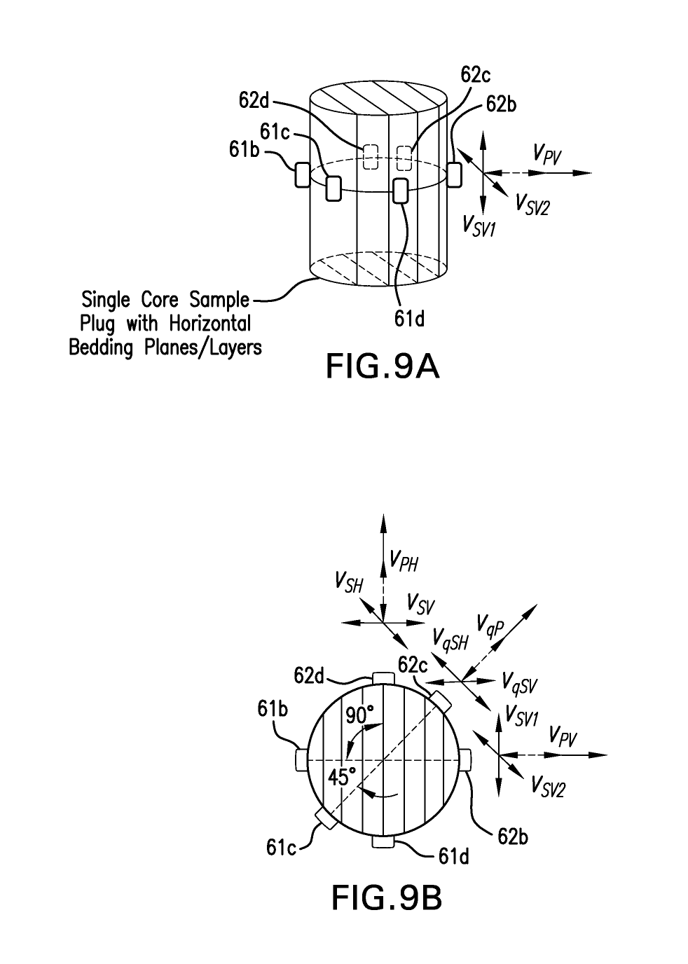

In another embodiment, the core holder includes three sets of transducers—all three sets being radial sets of transducers as illustrated in FIG. 9. The three radial sets of source and receiver transducers are attached on the side face (radial direction) of the sample plug to measure the radial compressional and shear-wave velocities. The first radial set of source and receiver transducers (61b and 62b) is placed in such a way that the acoustic waves propagate perpendicular to the bedding/layer direction as illustrated in FIGS. 9A and 9B. The second radial set of source and receiver transducers (61c and 62c) is placed in a position in which acoustic waves propagate along the 45 degree direction relative to the bedding/layer direction as illustrated in FIGS. 9A and 9B. The third radial set of source and receiver transducers (61d and 62d) is placed in such a way that the waves propagate parallel to the bedding/layer direction as illustrated in FIGS. 9A and 9B.

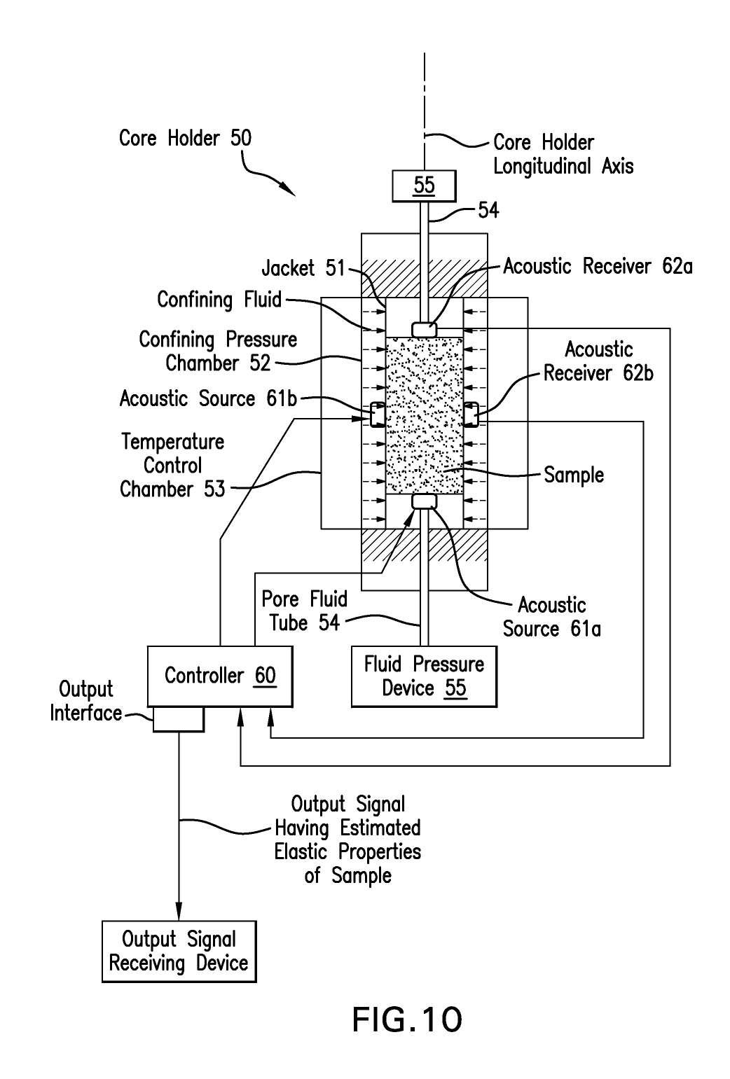

Refer now to FIG. 10, which illustrates a cross-sectional view of a core holder 50. The core holder 50 is configured to hold the sample plug in place and to position the acoustic transducers with respect to the bedding planes or layers so that the transducers are in locations described above for the various embodiments. The core holder 50 may also include springs or other devices (not shown) to urge the transducers to maintain contact with sample plug. The core holder 50 includes a jacket 51 that holds and secures the sample plug and the transducers. The jacket defines holes through which the transducers are disposed so as to maintain contact with the sample plug. Surrounding the jacket 51 is a confining pressure chamber 52 that is configured to apply a confining fluid pressure on the sample plug. Surrounding the pressure chamber 52 is a temperature control chamber 53 that is configured to apply and maintain a desired temperature on the sample plug. The core holder 50 also includes a pore fluid tube 54 that is in fluid communication with the pores of the sample plug. A fluid pressure device 55 is configured to apply and maintain a desired pore fluid pressure in the pores of sample plug via the pore fluid tube 54. It can be appreciated that the core holder 50 can maintain the temperature, confining pressure and pore pressure conditions of the environment from which the core sample was extracted.

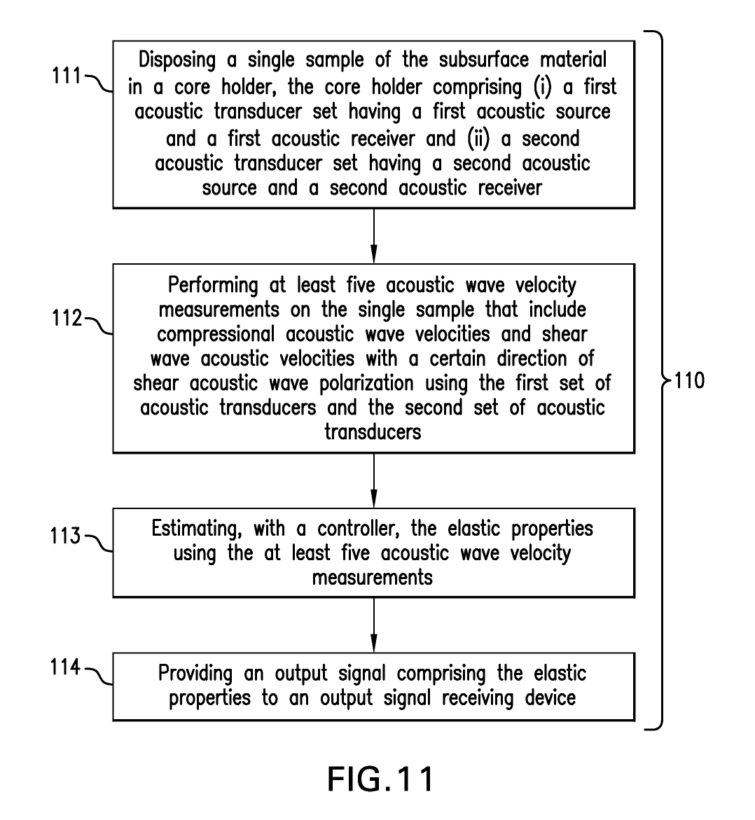

FIG. 11 is a flow chart for a method 110 for estimating a property of a subsurface material having bedding plane. Block 111 calls for disposing a single sample of the subsurface material in a core holder, the core holder comprising (i) a first acoustic transducer set having a first acoustic source and a first acoustic receiver and (ii) a second acoustic transducer set having a second acoustic source and a second acoustic receiver. In one or more embodiments, the single sample is a cylindrical core sample extracted from an earth formation by a downhole tool. The core sample may be transported to the surface of the earth where a plug sample (having dimensions similar to the interior of the core holder) may be extracted from it for being inserted into the core holder. Block 112 calls for performing at least five acoustic wave velocity measurements on the single sample using the first set of acoustic transducers and the second set of acoustic transducers. Block 113 calls for estimating, with a controller, the elastic properties using the at least five acoustic wave velocity measurements. Block 114 calls for providing an output signal comprising the elastic properties to an output signal receiving device.

The method 110 may also include conveying a downhole tool through a borehole penetrating the subsurface material, the downhole tool being configured to extract a core sample of the subsurface material. The method 110 may also include extracting the core sample from the subsurface material using the downhole tool and conveying the extracted core sample to the surface of the earth. At the surface of the earth, the method 110 may also include extracting a plug sample from the core sample for disposal of the single sample into the core holder. Alternatively, the method 110 may also include disposing the extracted core sample into the core holder where the core holder is located in the downhole tool. In this embodiment, the subsurface material can be tested downhole.

The method 110 may also include using an output interface to provide the output signal. The output signal may be used for at least one of displaying on a display the estimated elastic properties, recording the estimated elastic properties on a non-transitory computer readable medium, and printing the estimated elastic properties using a printer.

The above disclosed techniques provide several advantages. One advantage is that only a single sample of the subsurface material is required for testing in the core holder. This eliminates the difficulties in trying to extract three plug samples at different angles from one brittle core sample. Another advantage is that the testing can be performed more efficiently and with more precision using the core holder. Yet another advantage is that the core holder may be incorporated into the downhole tool for expedited testing with the estimated elastic properties being transmitted to the surface as soon as the elastic properties are estimated.

In support of the teachings herein, various analysis components may be used, including a digital and/or an analog system. For example, the downhole electronics 8, the computer processing system 9 or the controller 60 may include digital and/or analog systems. The system may have components such as a processor, storage media, memory, input, output, communications link (wired, wireless, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply, cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The terms “first,” “second” and the like do not denote a particular order, but are used to distinguish different elements.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for estimating elastic properties of a subsurface material having a bedding plane, the method comprising:
disposing a single sample of the subsurface material in a core holder, the core holder comprising (i) a first acoustic transducer set having a first acoustic source and a first acoustic receiver and (ii) a second acoustic transducer set having a second acoustic source and a second acoustic receiver;
performing at least five acoustic wave velocity measurements on the single sample that include compressional acoustic wave velocities and shear wave acoustic velocities with a certain direction of shear acoustic wave polarization using the first set of acoustic transducers and the second set of acoustic transducers;
estimating, with a controller, the elastic properties using the at least five acoustic wave velocity measurements; and
providing an output signal comprising the elastic properties to an output signal receiving device.

2. The method according to claim 1, further comprising conveying a downhole tool through a borehole penetrating the subsurface material, the downhole tool being configured to extract a core sample of the subsurface material.

3. The method according to claim 2, further comprising extracting the core sample from the subsurface material using the downhole tool.

4. The method according to claim 3, further comprising conveying the extracted core sample to the surface of the earth.

5. The method according to claim 4, further comprising extracting a plug sample from the core sample for disposal of the single sample into the core holder.

6. The method according to claim 3, further comprising disposing the extracted core sample into the core holder, the core holder being disposed in the downhole tool.

7. The method according to claim 1, wherein the at least five acoustic wave velocity measurements comprise:
a parallel compression wave velocity measurement (V_{PH}) of a compression acoustic wave traveling parallel to the bedding plane;
a parallel shear wave velocity measurement (V_{SH}) of a shear acoustic wave traveling parallel to the bedding plane and polarized parallel to the bedding plane;
a perpendicular compression wave velocity (V_{PV}) of a compression acoustic wave traveling perpendicular to the bedding plane;
a perpendicular shear wave velocity measurement (V_{SV1}) of a shear acoustic wave traveling perpendicular to the bedding plane and polarized parallel to the bedding plane; and
a quasi-compression wave velocity (V_{qP}) of a compression acoustic wave traveling at a 45 degree angle with respect to a direction of the bedding plane.

8. The method according to claim 7, further comprising using the first acoustic transducer set to measure (V_{PH}) and (V_{SH}) and the second acoustic transducer set to measure (V_{PV}), (V_{SV1}), and (V_{qP}).

9. The method according to claim 1, wherein providing an output signal comprises using an output interface.

10. The method according to claim 1, further comprising at least one of displaying on a display the estimated elastic properties, recording the estimated elastic properties on a non-transitory computer readable medium, and printing the estimated elastic properties using a printer.

11. An apparatus for estimating elastic properties of a subsurface material having a bedding plane, the apparatus comprising:
a core holder configured to hold a single sample of the subsurface material;
a first acoustic transducer set coupled to the core holder and having a first acoustic source and a first acoustic receiver;
a second acoustic transducer set coupled to the core holder and having a second acoustic source and a second acoustic receiver; and
a controller coupled to the first acoustic transducer set and the second acoustic transducer set, the controller being configured to (i) control operation of the first acoustic transducer set and the second acoustic transducer set in order to measure at least five acoustic wave velocities that include compressional acoustic wave velocities and shear wave acoustic velocities with a certain direction of shear acoustic wave polarization and (2) estimate the elastic properties using the at least five acoustic wave velocities that include compressional acoustic wave velocities and shear wave acoustic velocities with a certain direction of shear acoustic wave polarization.

12. The apparatus according to claim 11, wherein the sample is disposed in the core holder such that the direction of the bedding plane is parallel to a longitudinal axis of the core holder.

13. The apparatus according to claim 12, wherein the at least five acoustic wave velocities comprise:
a parallel compression wave velocity measurement (V_{PH}) of a compression acoustic wave traveling parallel to the bedding plane;
a parallel shear wave velocity measurement (V_{SH}) of a shear acoustic wave traveling parallel to the bedding plane and polarized parallel to the bedding plane;
a perpendicular compression wave velocity (V_{PV}) of a compression acoustic wave traveling perpendicular to the bedding plane;
a perpendicular shear wave velocity measurement (V_{SV1}) of a shear acoustic wave traveling perpendicular to the bedding plane and polarized parallel to the bedding plane; and
a quasi-compression wave velocity (V_{qP}) of a compression acoustic wave traveling at a 45 degree angle with respect to a direction of the bedding plane.

14. The apparatus according to claim 13, wherein:
the first acoustic source is disposed at one axial end of the core holder and the first acoustic receiver is disposed at another axial end of the core holder, the first acoustic transducer set being configured to measure (V_{PH}) and (V_{SH}); and
the second acoustic source is disposed radially with respect to the longitudinal axis and the second acoustic receiver is disposed radially opposite to of the second acoustic source, the second acoustic transducer set being configured to measure (V_{PV}), (V_{SV1}), and (V_{qP}).

15. The apparatus according to claim 14, wherein the core holder is configured to rotate the sample 45 degrees with respect to the second acoustic transducer set, rotate the second transducer set 45 degrees with respect to the sample, or some combination of rotation that results in the second acoustic transducer set measuring (V_{qP}).

16. The apparatus according to claim 14, wherein the apparatus further comprises a third acoustic transducer set coupled to the core holder, disposed radially with respect to the longitudinal axis and at a 45 degree angle with respect to the direction of the bedding plane, and configured to measure (V_{qP}).

17. The apparatus according to claim 13, wherein:
the first acoustic transducer set is disposed radially with respect to the longitudinal axis and parallel to the direction of the bedding plane and configured to measure (V_{PH}) and (V_{SH});
the second acoustic transducer set is disposed radially with respect to the longitudinal axis and perpendicular to the direction of the bedding plane and configured to measure (V_{PV}) and (V_{SV1}); and
the apparatus further comprises a third acoustic transducer set coupled to the core holder, disposed radially with respect to the longitudinal axis and at a 45 degree angle with respect to the direction of the bedding plane, and configured to measure (V_{qP}).

18. The apparatus according to claim 11, wherein the core holder comprises a jacket configured to contain the sample and a pressure control chamber containing a pressure control fluid that surrounds the jacket, the pressure control chamber being configured to apply a confining pressure to the sample via the pressure control fluid, the jacket being configured to isolate the pressure confining fluid from the sample.

19. The apparatus according to claim 18, wherein the core holder further comprises a temperature control chamber at least partially surrounding the pressure control chamber, the temperature control chamber being configured to maintain the sample at a desired temperature for the acoustic wave velocity measurements.

20. The apparatus according to claim 19, wherein the core holder further comprises a pore fluid tube in fluid communication with pores of the sample and pore fluid pressure device configured to apply and maintain a desired pore fluid pressure in the pores of the sample via the pore fluid tube.
